(19) United States
(12) Patent Application Publication
(10) Pub. No.: US 2005/0221116 A1
(43) Pub. Date: Oct. 6, 2005

(54) Organic electroluminescent device with chromophore dopants

(76) Inventors: Massimo Cocchi, Bolonga (IT); Piergiulio Di Marco, Bologna (IT); Valeria Fattori, Bologna (IT); Gabriele Giro, Bologna (IT); Jan Kalinowski, Gdynia (PL); Waldemar Stampor, Gdansk (PL); Dalia Virgili, San Benedetto Del Tronto (IT)

Correspondence Address: BERENATO, WHITE & STAVISH, LLC, 6550 ROCK SPRING DRIVE, SUITE 240, BETHESDA, MD, 20817, US

(21) Appl. No.: 10/509,111

(22) PCT Filed: Mar. 28, 2003
(86) PCT No.: PCT/IT03/00187

§ 371 Date: May 27, 2005

(30) Foreign Application Priority Data
Mar. 29, 2002 (IT) BO2002A 000165

(51) Int. Cl. H05B 33/14

(52) U.S. Cl. 428/690; 428/917; 428/212; 313/504; 313/506; 427/66

(57) ABSTRACT

An organic electroluminescent device having an anode, a cathode, and an intermediate element, which is set between the anode and the cathode and contains hole-transporting organic material, electron-transporting organic material, and luminophore material; the electron-transporting organic material and the hole-transporting organic material being designed to form between them molecular complexes in an excited state (exciplexes or electroplexes); the luminophore material being designed to emit electromagnetic radiation and being supplied, in use, for transfer of energy from the molecular complexes in the excited state.

### TECHNICAL FIELD

The present invention relates to an organic electroluminescent device.

### BACKGROUND ART

In the field of organic electroluminescent devices (OLEDs) there has recently been proposed an organic electroluminescent device having an anode, a cathode, and an intermediate element, which is set between the anode and the cathode and comprises at least one hole-transporting organic material and at least one electron-transporting organic material. The electron-transporting organic material and the hole-transporting organic material are designed to form between them exciplexes or electroplexes.

Here and throughout the ensuing text the expression “exciplex or electroplex” is used to mean the combination of at least two molecules in an excited state, which, decaying, dissociates into its constituent molecules and emits electromagnetic radiation or transfers energy to a acceptor molecule.

Known electroluminescent devices of the type described above have a relatively low efficiency.

In addition, the variation in the wavelength of emission of this type of devices is obtained in a relatively complex manner. In this regard, it is important to emphasize that, to obtain different wavelengths, it is necessary to change the hole-transporting organic material and/or the electron-transporting organic material. These variations may lead to a reduction in the efficiency of the device and entail laborious research to identify a better combination of the hole-transporting organic material and the electron-transporting organic material.

### DISCLOSURE OF INVENTION

The purpose of the present invention is to provide an organic electroluminescent device, which is free from the drawbacks mentioned above and is, at the same time, easy and inexpensive to manufacture.

According to the present invention, an organic electroluminescent device is provided, which has an anode, a cathode and an intermediate element, which is set between the anode and the cathode and comprises at least one hole-transporting organic material and at least one electron-transporting organic material; the electron-transporting organic material and the hole-transporting organic material being designed to form between them exciplexes or electroplexes; the device being characterized in that said intermediate element comprises at least one luminophore material, the luminophore material being designed to emit electromagnetic radiation and being supplied, in use, for transfer of energy from said exciplexes or electroplexes.

The device defined above, in which the intermediate element has an intermediate layer, which comprises a mixture of hole-transporting organic material and electron-transporting organic material, is relatively costly and difficult to manufacture. In this connection, it should be pointed out that the intermediate layer of the type described is usually obtained by means of a relatively complex and difficult operation, namely, a simultaneous sublimation of two substances having chemico-physical characteristics that are different from one another.

Consequently, according to a preferred embodiment, the intermediate element essentially includes a first layer, which comprises the hole-transporting organic material and is set in contact with the anode, and a second layer, which comprises the electron-transporting organic material and is set in contact with said cathode and said first layer.

Here and in the ensuing text, the expression “essentially including” does not mean that the organic electroluminescent device cannot include other constituents, but means that there is not present between the anode and the cathode a layer that comprises a mixture of the electron-transporting organic material and of the hole-transporting organic material.

It is possible that, in use, the exciplexes and electroplexes that are formed diffuse within the first layer, which contains the material for transporting holes.

Consequently, in order to increase the efficiency of this type of device, preferably the aforesaid first layer comprises the luminophore material.

In the device described above, it is possible that leakage currents will be created, which do not contribute to the emission of electromagnetic radiation and are due, above all, to positive currents (i.e., a transfer of holes between adjacent molecules) that start from the anode, traverse the first and the second layer, and discharge at the cathode. The passage of charge between the first and second layers occurs as a consequence of an electron jump from the HOMO of the electron-transporting organic material to the HOMO (in which a hole is present) of the hole-transporting organic material. These currents, in addition to diminishing the efficiency of the OLED, raise the temperature, causing morphological alterations of the first layer and of the second layer, with consequent damage to the device.

For the above reason, preferably, said electron-transporting organic material has a first ionization potential and said hole-transporting organic material has a second ionization potential, the first ionization potential being higher by at least 0.7 eV than the second ionization potential.

Furthermore, it is possible, albeit with relatively less likelihood, that leakage currents will be created, which do not contribute to the emission of the electromagnetic radiation and are due above all to negative currents (i.e., passage of electrons between adjacent molecules) that start from the cathode, traverse the second and first layers, and discharge at the anode. The passage of charge between the second and first layers occurs, in this case, as a consequence of an electron jump from the LUMO of the electron-transporting organic material to the LUMO of the hole-transporting organic material.

Also the negative currents, in addition to diminishing the efficiency of the OLED, raise the temperature, causing morphological alterations of the first and second layers, with consequent damage to the device.

Consequently, according to a preferred embodiment, said electron-transporting organic material has a first electronic affinity and said hole-transporting organic material has a second electronic affinity, the first electronic affinity being higher by at least 0.4 eV than the second electronic affinity.

The present invention moreover relates to a method for the fabrication of an organic electroluminescent device.

According to the present invention, a method is provided for the fabrication of an organic electroluminescent device according to the contents of claim 26.

### BRIEF DESCRIPTION OF THE DRAWINGS

The invention will now be described with reference to the annexed drawings, which illustrate some non-limiting examples of embodiment thereof in which:

FIG. 1 is a cross section of a first embodiment of the device according to the present invention;

FIG. 2 is a perspective view, with parts removed for reasons of clarity, of a detail of a second embodiment of the device according to the present invention;

FIG. 3 illustrates a spectrum of emission of a device built according to Example 1;

FIG. 4 is an experimental graph representing the function intensity of electroluminescence vs. applied voltage, and the function current density vs. applied voltage of a device built according to Example 1;

FIG. 5 is an experimental graph representing the function efficiency vs. applied voltage of a device built according to Example 1;

FIG. 6 illustrates a spectrum of emission of a device built according to Example 2;

FIG. 7 is an experimental graph representing the function intensity of electroluminescence vs. applied voltage and the function current density vs. applied voltage of a device built according to Example 2;

FIG. 8 is an experimental graph representing the function efficiency vs. applied voltage of a device built according to Example 2;

FIG. 9 illustrates a spectrum of emission of a device built according to Example 3;

FIG. 10 is an experimental graph representing the function intensity of electroluminescence vs. applied voltage and the function current density vs. applied voltage of a device built according to Example 3;

FIG. 11 is an experimental graph representing the function efficiency vs. applied voltage of a device built according to Example 3;

FIG. 12 illustrates a spectrum of emission of a device built according to Example 4;

FIG. 13 is an experimental graph representing the function intensity of electroluminescence vs. applied voltage and the function current density vs. applied voltage of a device built according to Example 4;

FIG. 14 is an experimental graph representing the function efficiency vs. applied voltage of a device built according to Example 4;

FIG. 15 illustrates a spectrum of emission of a device built according to Example 5;

FIG. 16 is an experimental graph representing the function intensity of electroluminescence vs. applied voltage and the function current density vs. applied voltage of a device built according to Example 5;

FIG. 17 is an experimental graph representing the function efficiency vs. applied voltage of a device built according to Example 5;

FIG. 18 illustrates a spectrum of emission of a device built according to Example 6;

FIG. 19 is an experimental graph representing the function intensity of electroluminescence vs. applied voltage and the function current density vs. applied voltage of a device built according to Example 6;

FIG. 20 is an experimental graph representing the function efficiency vs. applied voltage of a device built according to Example 6;

FIG. 21 illustrates a spectrum of emission of a device built according to Example 7;

FIG. 22 illustrates a spectrum of emission of a device built according to Example 9;

FIG. 23 is an experimental graph representing the function intensity of electroluminescence vs. applied voltage and the function current density vs. applied voltage of a device built according to Example 9;

FIG. 24 is an experimental graph representing the function efficiency vs. applied voltage of a device built according to Example 9;

FIG. 25 illustrates a spectrum of emission of a device built according to Example 10;

FIG. 26 is an experimental graph representing the function intensity of electroluminescence vs. applied voltage and the function current density vs. applied voltage of a device built according to Example 10;

FIG. 27 is an experimental graph representing the function efficiency vs. applied voltage of a device built according to Example 10;

FIG. 28 illustrates a spectrum of emission of a device built according to Example 11;

FIG. 29 is an experimental graph representing the function intensity of electroluminescence vs. applied voltage and the function current density vs. applied voltage of a device built according to Example 11; and

FIG. 30 is an experimental graph representing the function efficiency vs. applied voltage of a device built according to Example 11.

### BEST MODE FOR CARRYING OUT THE INVENTION

With reference to FIG. 1, the number 1 designates as a whole an organic electroluminescent device comprising an anode 2 and a cathode 3 that are separated from one another by a layer 4, which comprises at least one hole-transporting organic material, and by a layer 6, which comprises at least one electron-transporting organic material. The layer 4 and the layer 6 are in contact with one another, but are substantially separated. The hole-transporting organic material is designed to combine with the electron-transporting organic material so as to form exciplexes or electroplexes, which, by decaying from one of their electrically excited states, are able to emit electromagnetic radiation or to transfer energy to acceptor molecules.

The layer 4 and the layer 6 form part of an intermediate element 7 set between the anode 2 and the cathode 3.

The layer 4 comprises at least one luminophore material constituted by acceptor molecules, which, once excited, are able to emit electromagnetic radiation by fluorescence or phosphorescence.

Preferably, the layer 4 further comprises a material for bestowing mechanical solidity on the layer itself, for example polycarbonate.

The cathode 3 and the anode 2 are connected (in a known way and here schematically illustrated) to an external current generator 8, which is designed to induce a potential difference between the cathode 3 and the anode 2.

The layer 4 is designed to transfer holes, which are caused, in use, by the oxidative processes that occur at the anode 2, from the anode 2 towards the layer 6. The layer 4 is set in contact with the anode 2 and with the layer 6, so as to be positioned on the opposite side of the layer 4 with respect to the cathode 3.

The layer 6 is designed to transfer electrons coming from the cathode 3 towards the layer 4 and is set in contact with the cathode 3 and on the opposite side of the layer 4 with respect to the anode 2.

A glass substrate 9 is set on the opposite side of the anode 2 with respect to the layer 4 and provides a mechanical support for the anode 2, which has a relatively thin layer of a material with high work function, for example calcium or indium and tin oxide (ITO). In this connection, it is important to emphasize that both the anode 2 and the glass substrate 9, since they are transparent, enable passage of light.

The cathode 3 is provided with a layer, which is made of a material with low work function, for example calcium, and is set in contact with a layer of silver 10.

According to a further embodiment (not illustrated), the luminophore material is set substantially at an interface 11 defined by the layers 4 and 5.

Fabrication of the organic electroluminescent device 1 is carried out using a method, which comprises a deposition step for depositing the intermediate element 7 on the anode 2 and an apposition step for positioning a cathode 3 on the intermediate element 7.

The luminophore material is chosen so that the electromagnetic radiation, which is emitted, in use, by the luminophore material, is of a given wavelength

Preferably, the deposition step comprises a first deposition substep for depositing the first layer 4 on the anode 2 and a second deposition substep for depositing the second layer 6 on the first layer 4.

During said first deposition substep, the luminophore material and, preferably, the polycarbonate (PC) are deposited.

In use, the current generator 8 is actuated so as to generate a difference of potential between the anode 2 and the cathode 3. The holes that are created at the anode 2 in the hole-transporting organic material transfer, on account of the electric field generated between the cathode 3 and the anode 2, as far as an interface 11. Likewise, the electrons transferred from the cathode to the electron-transporting organic material transfer through the layer 6 as far as the interface 11.

At this point, the molecular cations of the layer 4 and the molecular anions of the layer 6 combine at the interface 11 so as to form exciplexes or electroplexes, i.e., combinations of at least two molecules in an excited state, which diffuse partially within the first layer 4 and decay, transferring energy to the acceptor molecules of the luminophore material. The acceptor molecules of the luminophore material thus excited emit electromagnetic radiation by fluorescence or phosphorescence.

There basically exist two mechanisms currently discussed for the transfer of energy from a donor molecule in an excited state to a acceptor molecule. The first mechanism is the transfer of a Dexter type (D. L. Dexter, “A theory of sensitized luminescence in solids” J. Chem. Phys. 1953, 21, 836-850), according to which an exciton jumps from the donor molecule to the acceptor molecule. Transfer of a Dexter type is a relatively short-range transfer (i.e., it occurs between relatively close molecules), depends upon the superposition of the orbitals of the donor molecule to the orbitals of the acceptor molecule, and occurs in such a way as to conserve spin symmetry according to the possible relations:
¹D*+¹A→¹D+¹A*
or
³D*+¹A→¹D+³A*

The second mechanism is the transfer of a Förster type (T. Förster, Zwischenmolekulare Energiewarung und Fluoreszenz, Annalen der Physik, 1948, 2, 55-75), which occurs by means of a pairing of the dipoles of the donor molecule with the dipoles of the acceptor molecule. Transfer of a Förster type is a relatively long-range transfer (i.e., between relatively distant molecules) and occurs without necessarily conserving spin symmetry according to the possible relations:
¹D*+¹A→¹D+¹A*
or
³D*+¹A→¹D+¹A*

Surprisingly, the organic electroluminescent device 1 has a relatively high efficiency and enables, by varying the luminophore material, to vary the wavelength of emission.

In this connection, it is important to highlight the fact that the efficiency of the device 1 (η_{TE}) is, inter alia, a function of the ratio between the mean time of transfer of energy (τ_{TE}) between donor molecules and acceptor molecules and the mean time of deactivation (τ_{d}) of the donor molecules in an excited state via other deactivation means (for example, thermal degradation), substantially according to the function:
η_{TE}∝1/(1+τ_{TE}/τ_{d})

In this connection, it is to be pointed out that η_{TE} tends to 1 when τ_{TE}/τ_{d} tends to 0, that the mean time of deactivation of the donor molecules in an excited state is characteristic of the type of molecules, and that the mean energy-transfer time is a function of the ratio between the concentration of the acceptor molecules and the concentration of the donor molecules.

The donor molecules that are generally used in other organic electroluminescent devices have mean deactivation times not substantially longer than 10 nanoseconds.

On the other hand, the exciplexes or electroplexes, which in the device 1 act as donor molecules, have mean deactivation times not substantially shorter than 100 nanoseconds.

From what has been set forth above, it emerges that the selection of the electron-transporting organic material, of the hole-transporting organic material, and of the luminophore material must be made with care. In particular, the hole-transporting organic material and the electron-transporting organic material must be chosen so as to be able to form between them exciplexes or electroplexes.

In order to improve the efficiency of the organic electroluminescent device 1, it is preferable for the electron-transporting organic material to have the ionization potential higher by at least 0.7 eV than the ionization potential of the hole-transporting organic material. In this way, the electrons present on the HOMO of the electron-transporting organic material, which is set at the interface 11, basically do not succeed in passing onto the HOMO of the hole-transporting organic material, which is set at the interface 11.

It is moreover preferable for the electronic affinity of the electron-transporting organic material to be higher by at least 0.4 eV than the electronic affinity of the hole-transporting organic material. Like this, in a way similar to what occurs in the case of the holes, the electrons coming from the cathode present on the LUMO of the electron-transporting organic material, which is set at the interface 11, basically fail to pass onto the LUMO of the hole-transporting organic material, which is set at the interface 11.

By so choosing the electron-transporting organic material and the hole-transporting organic material, leakage currents, which do not contribute to the emission of electromagnetic radiation, are substantially limited.

Preferably, the electron-transporting organic material is selected in such a way that its electronic affinity will be relatively close to the work function of the material of which the cathode is substantially made, and the hole-transporting organic material is selected in such a way that its ionization potential will be relatively close to the work function of the material of which the anode is substantially made.

The hole-transporting organic material preferably comprises a tertiary aromatic amine which is able to transfer holes and satisfies the structural formula (I): 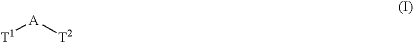
in which T¹ and T² represent, each independently of the other, a tertiary amine, and in which A represents an aryl group.

By the expression “each independently of the other” is meant the fact that T¹ and T² can be identical to one another or different from one another.

Preferably, T¹ and T² represent, each independently of the other, a tertiary amine that satisfies the structural formula (II) or the structural formula (III): 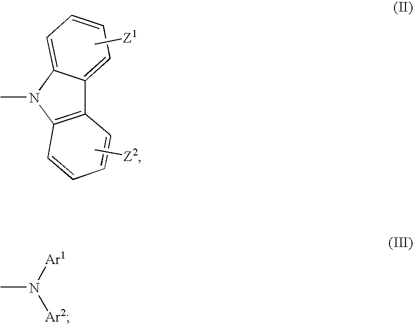
in which Z¹ and Z², represent, each independently of the other, an alkyl group, an alcohol group, or a hydrogen atom; and
in which Ar¹ and Ar² represent, independently of one another, an aryl group.

In particular, the hole-transporting organic material comprises 4,4′,4″-tris (N-3-methylphenyl-N-phenylamino)-triphenylamine (m-MTDATA), N,N′-bis-(3-methylphenyl)-N,N′-bis-(phenyl)-benzidine (TPD), 4,4′,4″-tri(N,N-diphenyl-amino)-triphenylamine (TDATA) and/or 4,4′,4″-tri(carbazol-9-yl)-triphenylamine (TCTA).

The electron-transporting organic material comprises, preferably, an oxydiazole that satisfies the structural formula (IV) or a triazole that satisfies the structural formula (V): 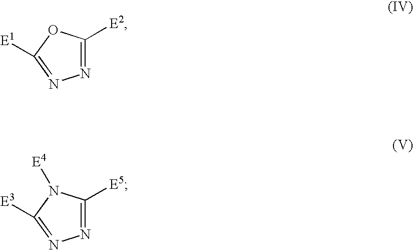
in which E¹, E², E³, E⁴ and E⁵ are, each independently of the others, an aryl group.

In particular, the electron-transporting organic material comprises 3,5-bi(4-ter-butyl-phenyl)-4-phenyl-triazole (TAZ) and/or 3-(4-diphenylyl)-4-phenyl-5-ter-butylphenyl-1,2,4-triazole (PBD).

According to one embodiment, the luminophore material comprises at least one metallocyclic compound, which satisfies the structural formula M L L′ L″ or M′ L L′, in which M and M′ represent a transition metal, L, L′ and L″ represent, each independently of the others, a chelating ligand, which satisfies the structural formula: 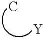
in which Y represents an electron-donor heteroatom.

M′ represents platinum or palladium.

Preferably, M represents iridium (Ir).

Preferably, M and M′ are positively formally charged, and the chelating ligands, L, L′ and L″ satisfy, each independently of the others, one of the following structural formulas: 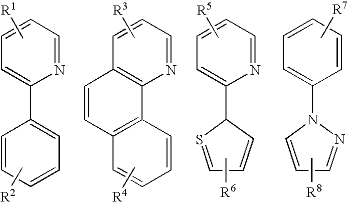
in which R¹, R², R³, R⁴, R⁵, R⁶, R⁷, and R⁸ represent, each independently of the others, an alkyl group, an aryl group, a condensate ring, a hydrogen atom, L, L′ and L″ being negatively formally charged.

Preferably, the metallocyclic compound is iridium tris (2-phenylpyridine) (Ir(ppy)₃), platinum bis (2-thienylpyridine) (Pt(tpy)₂) or platinum bis (2-phenylpyridine) (Pt(ppy)₂).

According to a further embodiment, the luminophore material comprises at least one organometallic complex which satisfies the structural formula:
M″ Qₙ A₃₋ₙ or M′″ Qₘ A₂₋ₘ,
in which n is comprised between 1 and 3, m is 1 or 2, each Q represents, independently of the other Qs, a quinoline derivative, each A represents, independently of the other As, a phenol derivative, M″ has a positive formal charge and represents aluminium (Al), or gallium (Ga), and in which M′″ has a positive formal charge and represents zinc (Zn), or beryllium (Be).

Preferably, each Q represents, independently of the other Qs, a quinoline derivative having one of the following structural formulas: 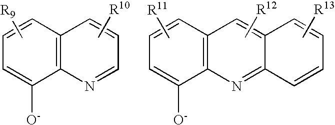
in which R⁹, R¹⁰, R¹¹, R¹² and R¹³ represent, each independently of the others, an alkyl group, a hydrogen atom, or an aryl group.

Preferably, moreover, each A is a phenol derivative, which satisfies, each independently of the other As, one of the following structural formulas: 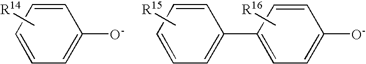
in which R¹⁴, R¹⁵ and R¹⁶ represent, each independently of the others, an alkyl group, a hydrogen atom, or an aryl group.

Preferably, the organometallic complex is alumino bis (phenol)(8-hydroxyquinaldine) (Alqfen2).

According to a further embodiment, the luminophore material comprises at least one aromatic hydrocarbon with condensate rings which satisfies one of the following structural formulas: 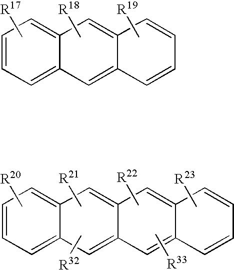
in which R¹⁷, R¹⁸, R¹⁹, R²⁰ , R²¹, R²² , R²³ , R³² and R³³ represent, each independently of the others, an alkyl group, a hydrogen atom, or an aryl group.

Preferably, the aromatic hydrocarbon with condensate rings is rubrene, the structural formula of which is:

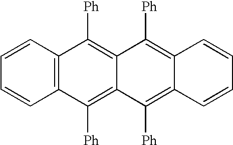

According to a further embodiment, the luminophore material comprises at least one thiophene derivative which satisfies one of the following structural formulas: 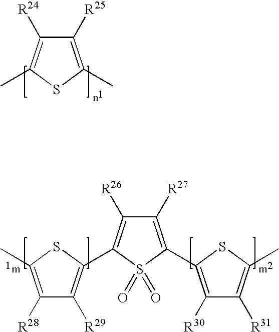
in which n¹ is an integer comprised between 3 and 7, m¹ and m² are, each independently of the other, integers comprised between 1 and 3, in which R²⁴, R²⁵, R²⁶, R²⁷, R²⁸, R²⁹, R³⁰ and R³¹ represent, each independently of the others, an alkyl group, a hydrogen atom, or an aryl group.

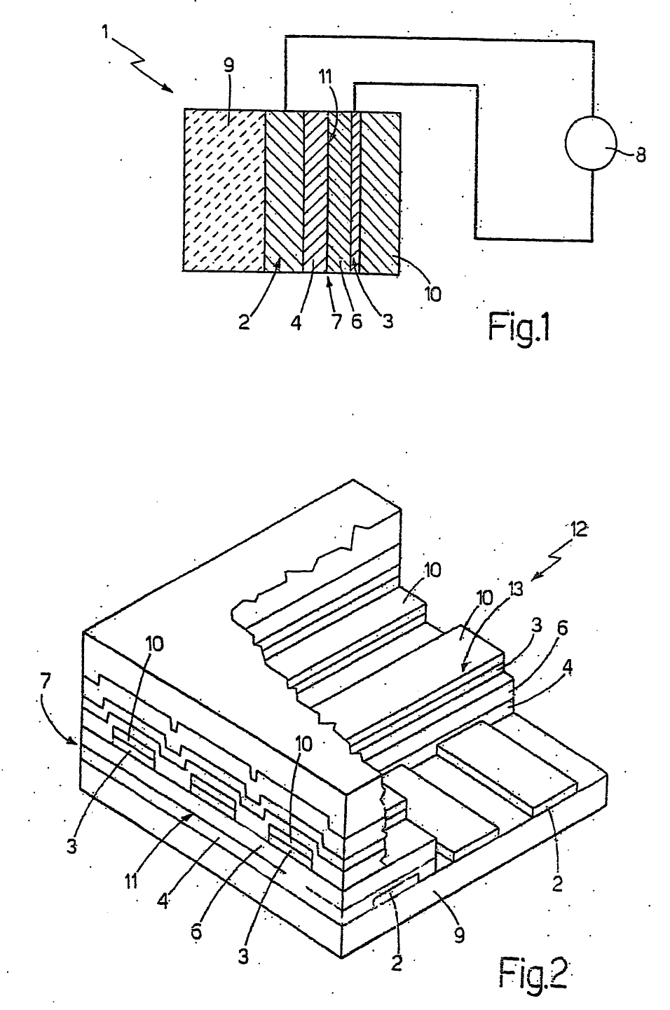

The variant illustrated in FIG. 2 relates to an organic electroluminescent device 12 similar to the device 1, and the parts of which are designated by the same reference numbers that designate the corresponding parts of the control device 1.

The device 12 differs from the device 1 substantially in that, in the device 12, there are present a plurality of anodes 2 and of cathodes 3 each having the shape of a parallelepiped with a rectangular base, the cathodes 3 lying on a plane that is different from, and parallel to, the plane on which the anodes 2 lie. The layers 4 and 6 are set between the two planes. The longitudinal axes of the cathodes 3 are parallel to one another and transverse to the longitudinal axes of the anodes 2. In this way, the cathodes 3, by being set on top of the anodes 2, define a plurality of areas 13, each of which can light up individually and independently of the others.

Further characteristics of the present invention will emerge from the ensuing description of some non-limiting examples of the organic electroluminescent device 1.

### EXAMPLE 1

An organic electroluminescent device was prepared in the way described in what follows.

A plate of glass coated with a layer of indium and tin oxide, which had a thickness of approximately 100 nm and was substantially transparent, was cleaned by being dipped in a boiling solution of acetone and alcohol and by subsequently being put into an ultrasound washer for approximately thirty minutes.

At this point there was laid, using a spin coater, a first 60-nm thin film from a solution of 4,4′,4″-tris (N-3-methylphenyl-N-phenylamino)-triphenylamine (m-MTDATA): polycarbonate (PC): rubrene in the proportions 75:24:1 in dichloromethane. On top of this, by sublimation in a high-vacuum evaporator and at a pressure of 8×10⁻¹ Pa, there were deposited: a 60-nm layer of 2-(4-biphenyl)-5-phenyl-1,3,4-oxadiazole (PBD); a 25-nm layer of calcium; and a 100-nm layer of silver.

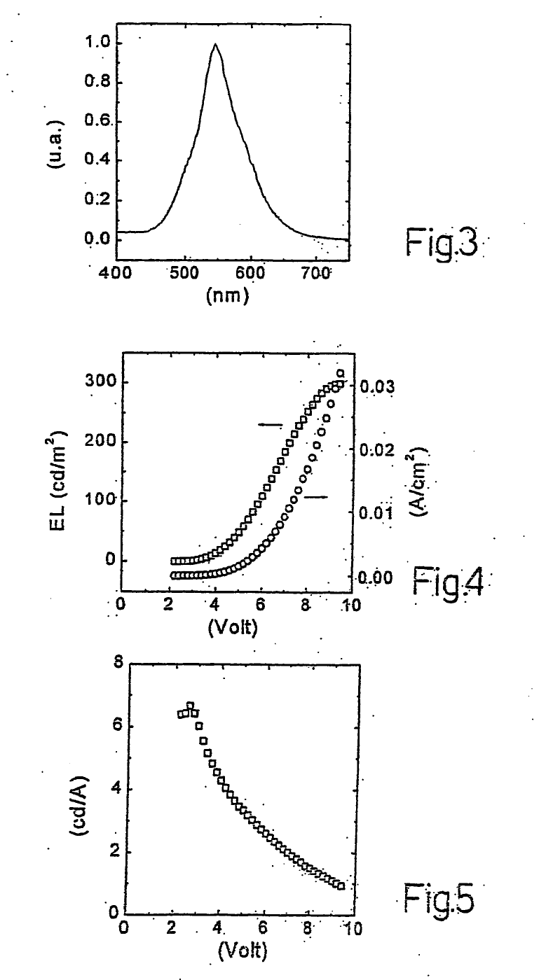

The device thus obtained, which had an active surface of 0.07 cm², was tested under laboratory conditions (i.e., with a temperature of between 20° C. and 24° C. and with a humidity of between 55% and 65%) and revealed an electromagnetic emission in the yellow having a spectrum, illustrated in FIG. 3, characteristic of rubrene. The curves which are obtained experimentally from the use of said device and which represent the intensity of electroluminescence and the current density as a function of the applied voltage are illustrated in FIG. 4. The curve obtained experimentally from the use of said device, which represents the efficiency as a function of the applied voltage is illustrated in FIG. 5.

Surprisingly, the device thus obtained has a relatively high efficiency.

### EXAMPLE 2

An organic electroluminescent device was prepared in a substantially identical way as the organic electroluminescent device of Example 1 except for the fact that, instead of the layer of m-MTDATA:PC:rubrene, there was deposited a layer of m-MTDATA:PC:Ir(ppy)₃ in the proportions 75:20:5. Ir(ppy)₃ is iridium tris (2-phenylpyridine).

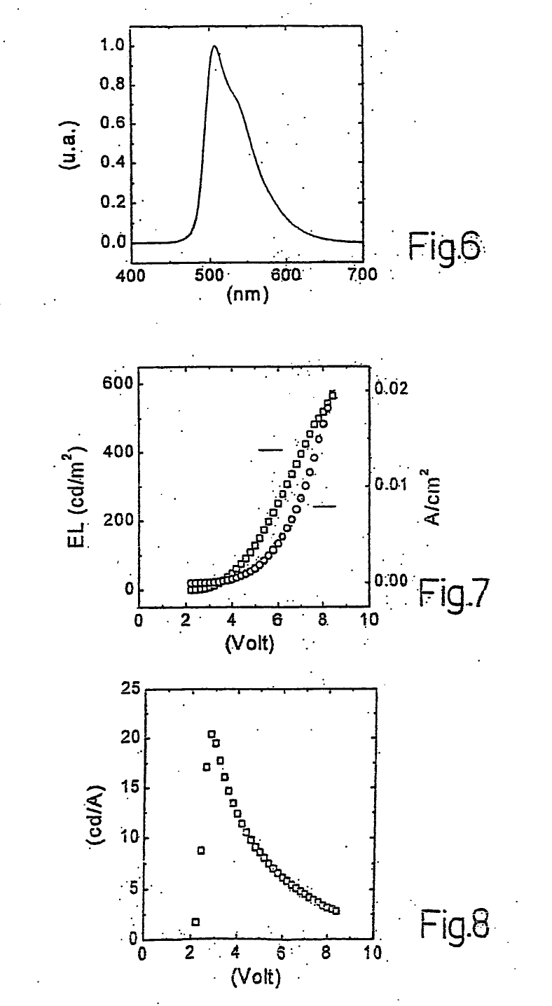

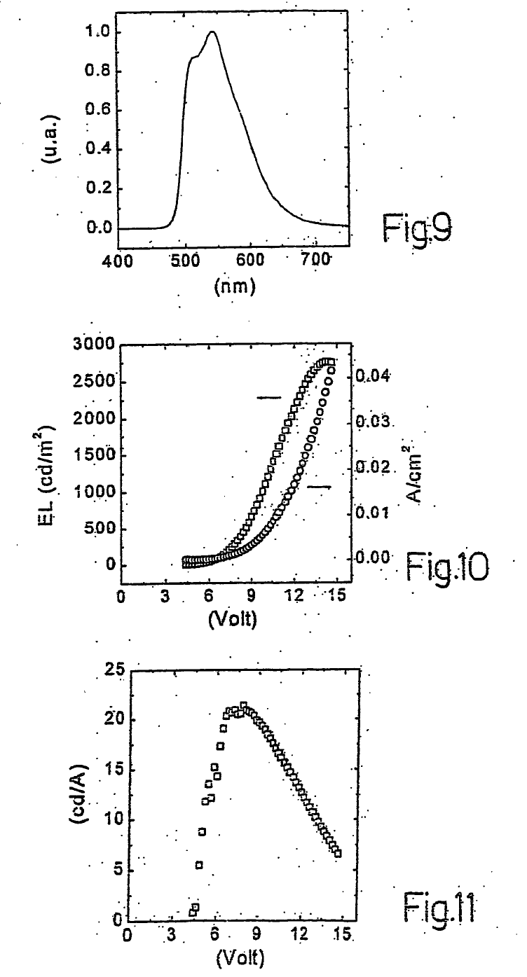

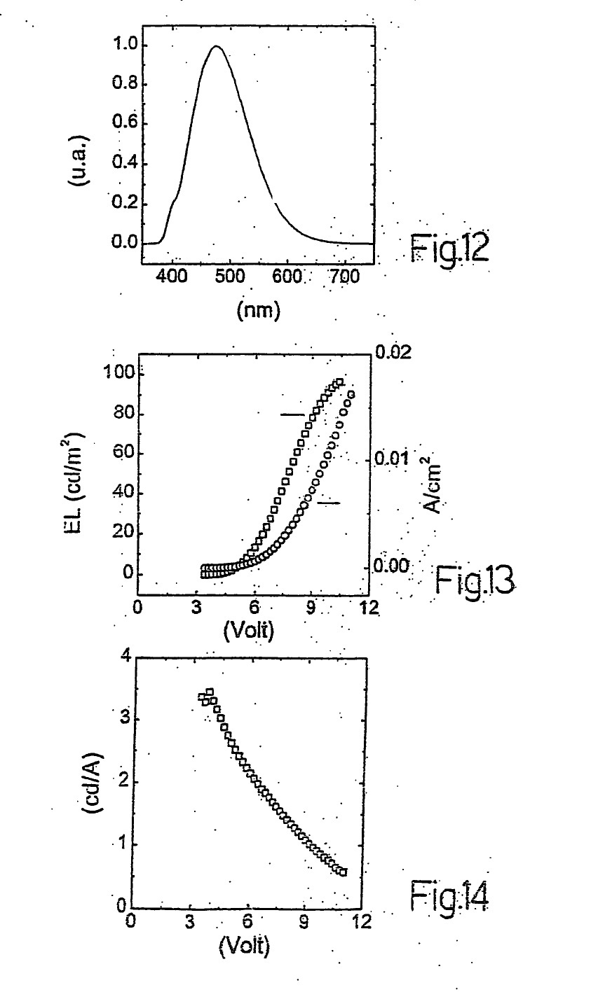

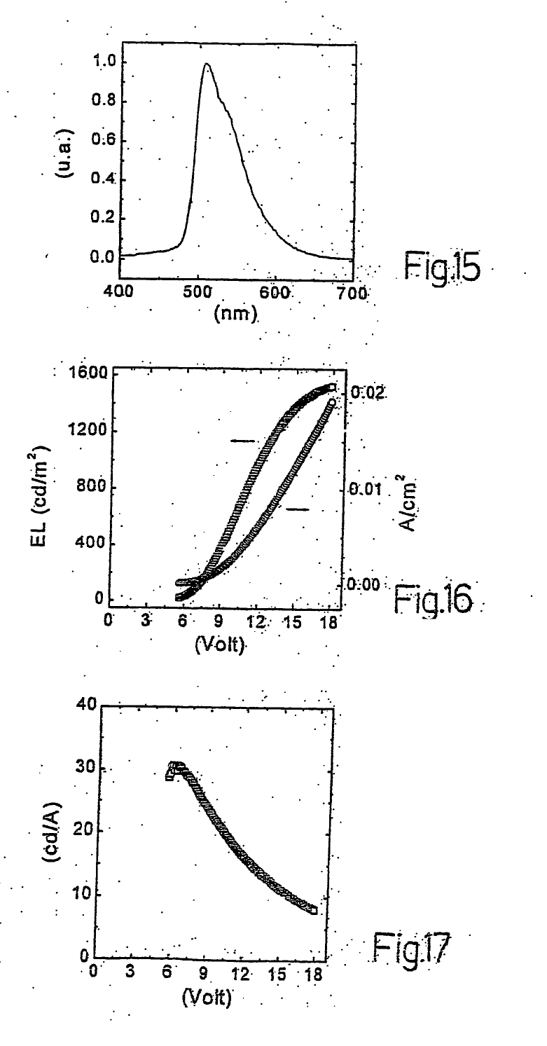

The device thus obtained, which had an active surface of 0.07 cm², was tested under laboratory conditions (i.e., with a temperature of between 20° C. and 24° C. and with a humidity of between 55% and 65%) and revealed an electromagnetic emission in the green having a spectrum, illustrated in FIG. 6, characteristic of Ir(ppy)₃. The curves which were obtained experimentally from the use of said device and which represent the intensity of electroluminescence and the current density as a function of the applied voltage are illustrated in FIG. 7. The curve which was obtained experimentally from the use of said device and which represents the efficiency as a function of the applied voltage is illustrated in FIG. 8.

Surprisingly, the device thus obtained has a relatively high efficiency.

### EXAMPLE 3

An organic electroluminescent device was prepared in a substantially identical way as the organic electroluminescent device of Example 1 except for the fact that, instead of the layer of m-MTDATA:PC:rubrene, there was deposited a layer of m-MTDATA:PC:Ir(ppy)₃:rubrene in the proportions 73:20:6:1.

The device thus obtained, which had an active surface of 0.07 cm², was tested under laboratory conditions (i.e., with a temperature of between 20° C. and 24° C. and with a humidity of between 55% and 65%) and revealed an electromagnetic emission in the green-yellow having a spectrum illustrated in FIG. 9. The curves which were obtained experimentally from the use of said device and which represent the intensity of electroluminescence and the current density as a function of the applied voltage are illustrated in FIG. 10. The curve, which was obtained experimentally from the use of said device and which represents the efficiency as a function of the applied voltage, is illustrated in FIG. 11.

Surprisingly, the device thus obtained has a relatively high efficiency.

### EXAMPLE 4

An organic electroluminescent device was prepared in a substantially identical way as the organic electroluminescent device of Example 1 except for the fact that, instead of the layer of m-MTDATA:PC:rubrene, there was deposited a layer of N,N′-bis-(3-methylphenyl)-N,N′-bis-(phenyl)-benzidine (TPD):PC:Alqfen₂ in the proportions 75:24:1. Alqfen₂ is aluminium bis (phenol)(8-hydroxyquinaldine).

The device thus obtained, which had an active surface of 0.07 cm², was tested under laboratory conditions (i.e., with a temperature of between 20° C. and 24° C. and with a humidity of between 55% and 65%) and revealed an electromagnetic emission in the blue having a spectrum, illustrated in FIG. 12, characteristic of Alqfen₂. The curves which were obtained experimentally from the use of said device and which represent the intensity of electroluminescence and the current density as a function of the applied voltage are illustrated in FIG. 13. The curve which was obtained experimentally from the use of said device and which represents the efficiency as a function of the applied voltage is illustrated in FIG. 14.

Surprisingly, the device thus obtained has a relatively high efficiency.

### EXAMPLE 5

An organic electroluminescent device was prepared in a substantially identical way as the organic electroluminescent device of Example 4 except for the fact that, instead of the layer of TPD:PC:Alqfen₂, there was deposited a layer of TPD:PC:Ir(ppy)₃ in the proportions 74:20:6.

The device thus obtained, which had an active surface of 0.07 cm², was tested under laboratory conditions (i.e., with a temperature of between 20° C. and 24° C. and with a humidity of between 55% and 65%) and revealed an electromagnetic emission in the green having a spectrum, illustrated in FIG. 15, characteristic of Ir(ppy)₃. The curves which were obtained experimentally from the use of said device and which represent the intensity of electroluminescence and the current density as a function of the applied voltage are illustrated in FIG. 16. The curve which was obtained experimentally from the use of said device and which represents the efficiency as a function of the applied voltage is illustrated in Figure 17.

Surprisingly, the device thus obtained has a relatively high efficiency.

### EXAMPLE 6

An organic electroluminescent device was prepared in a substantially identical way as the organic electroluminescent device of Example 4 except for the fact that, instead of the layer of TPD:PC:Alqfen₂, there was deposited a layer of TPD:PC:Ir(ppy)₃:rubrene in the proportions 73:20:6:1.

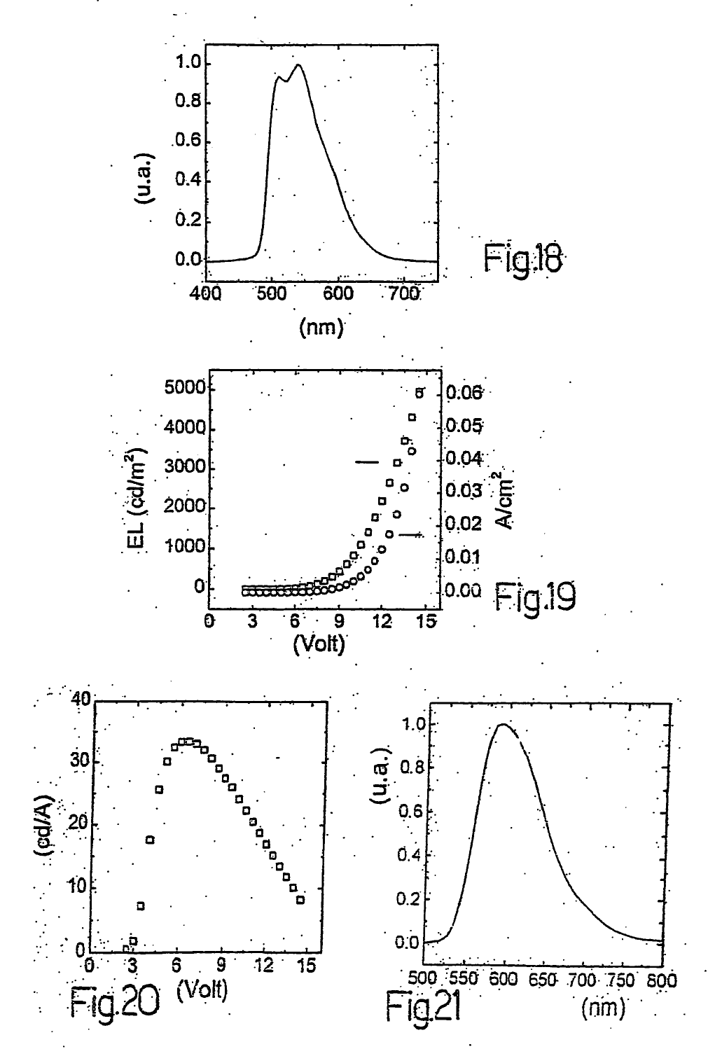

The device thus obtained, which had an active surface of 0.07 cm², was tested under laboratory conditions (i.e., with a temperature of between 20° C. and 24° C. and with a humidity of between 55% and 65%) and revealed an electromagnetic emission in the green-yellow having a spectrum illustrated in FIG. 18. The curves which were obtained experimentally from the use of said device and which represent the intensity of electroluminescence and the current density as a function of the applied voltage are illustrated in FIG. 19. The curve which was obtained experimentally from the use of said device and which represents the efficiency as a function of the applied voltage is illustrated in FIG. 20.

Surprisingly, the device thus obtained has a relatively high efficiency.

### EXAMPLE 7

An organic electroluminescent device was prepared in a substantially identical way as the organic electroluminescent device of Example 4 except for the fact that, instead of the layer of TPD:PC:Alqfen₂, there was deposited a layer of TPD: 3″,4′-dihexyl-2,2′:5′,2″:5″,2′″:5′″,2″″-quinquethiophene in the proportions 75:5.

3″,4′-dihexyl-2,2′:5′,2″:5″,2′″:5′″,2″″-quinquethiophene has the following structural formula:

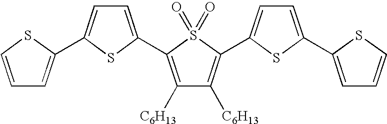

The device thus obtained, which had an active surface of 0.07 cm², was tested under laboratory conditions (i.e., with a temperature of between 20° C. and 24° C. and with a humidity of between 55% and 65%) and revealed an electromagnetic emission in the red-orange having a spectrum illustrated in FIG. 21.

Surprisingly, the device thus obtained has a relatively high efficiency.

### EXAMPLE 8

An organic electroluminescent device was prepared in a substantially identical way as the organic electroluminescent device of Example 4 except for the fact that, instead of the layer of TPD:PC:Alqfen₂, there was deposited a layer of TPD:Zn bis (hydroxyquinoline) in the following proportions 75:5.

The device thus obtained, which had an active surface of 0.07 cm², was tested under laboratory conditions (i.e., with a temperature of between 20° C. and 24° C. and with a humidity of between 55% and 65%), and revealed an electromagnetic emission in the green-yellow.

Surprisingly, the device thus obtained has a relatively high efficiency.

### EXAMPLE 9

An organic electroluminescent device was prepared in the manner described in what follows.

A plate of glass coated with a layer of indium and tin oxide, which had a thickness of approximately 100 nm and was substantially transparent, was cleaned by being dipped in a boiling solution of acetone and alcohol and by subsequently being put into an ultrasound washer for approximately thirty minutes.

At this point, there was laid, using a spin coater, a first 60-nm thin film from a solution of TPD: polycarbonate (PC): platinum bis (2-thienylpyridine) (Pt(tpy)₂) in the proportions 74:20:6 in dichloromethane; on top of this, by sublimation in a high-vacuum evaporator and at a pressure of 8×10⁻¹ Pa, there were deposited: a 60-nm layer of 2-(4-biphenyl)-5-phenyl-1,3,4-oxadiazole (PBD); a 25-nm layer of calcium; and a 100-nm layer of silver.

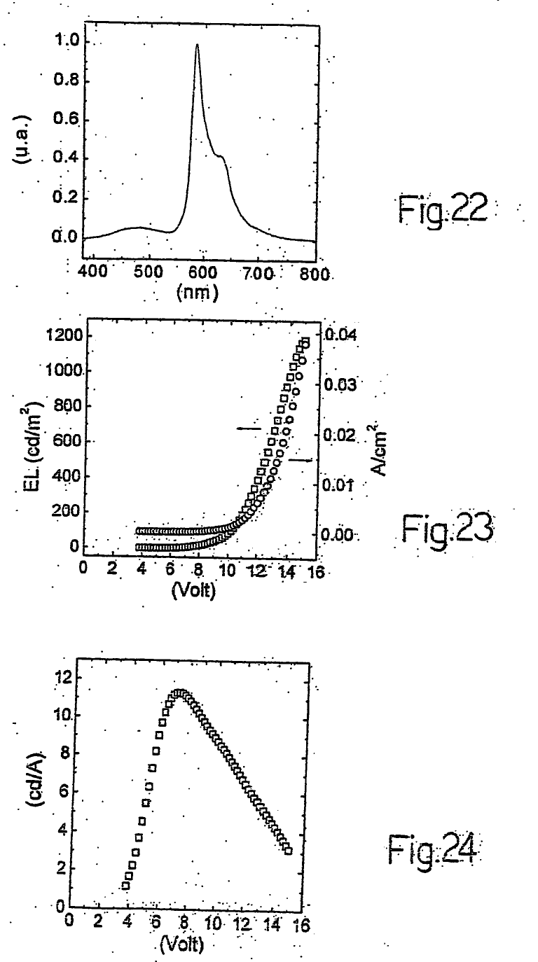

The device thus obtained, which had an active surface of 0.07 cm², was tested under laboratory conditions (i.e., with a temperature of between 20° C. and 24° C. and with a humidity of between 55% and 65%) and revealed an electromagnetic emission in the red-orange having a spectrum illustrated in FIG. 22, characteristic of the metallocyclic complex Pt(tpy)₂. The curves which were obtained experimentally from the use of said device and which represent the intensity of electroluminescence and the current density as a function of the applied voltage are illustrated in FIG. 23. The curve which was obtained experimentally from the use of said device and which represents the efficiency as a function of the applied voltage is illustrated in FIG. 24.

### EXAMPLE 10

An organic electroluminescent device was prepared in a substantially identical way as the organic electroluminescent device of Example 9 except for the fact that, instead of Pt(tpy)₂, Pt(ppy)₂ was used. Pt(ppy)₂ is platinum bis (2-phenylpyridine).

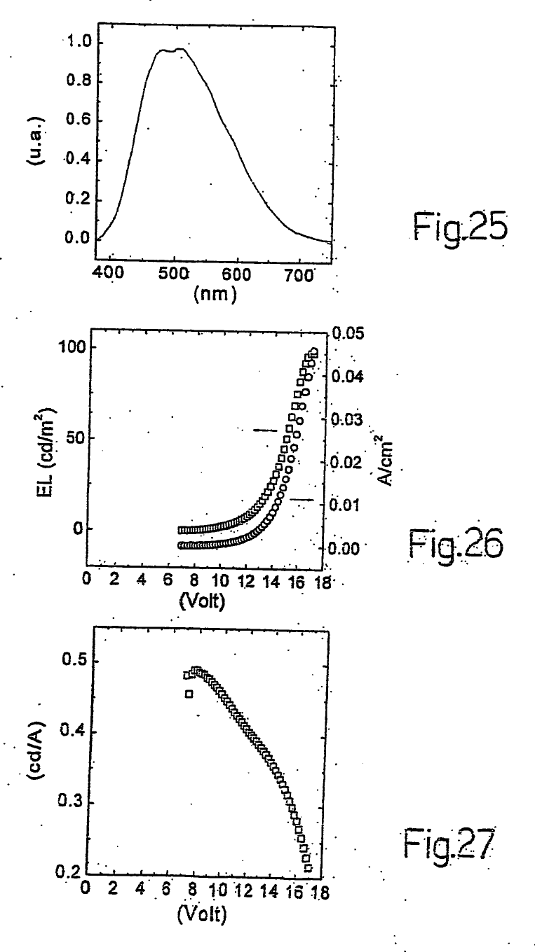

The device thus obtained, which had an active surface of 0.07 cm², was tested under laboratory conditions (i.e., with a temperature of between 20° C. and 24° C. and with a humidity of between 55% and 65%) and revealed an electromagnetic emission, illustrated in FIG. 25, in the blue-green. The curves which were obtained experimentally from the use of said device and which represent the intensity of electroluminescence and the current density as a function of the applied voltage are illustrated in FIG. 26. The curve which was obtained experimentally from the use of said device and which represents the efficiency as a function of the applied voltage is illustrated in FIG. 27.

### EXAMPLE 11

An organic electroluminescent device was prepared in a substantially identical way as the organic electroluminescent device of Example 10 except for the fact that a different proportion between the active molecules was used, namely, TPD:PC:Pt(ppy)₂ in a ratio of 40:20:40.

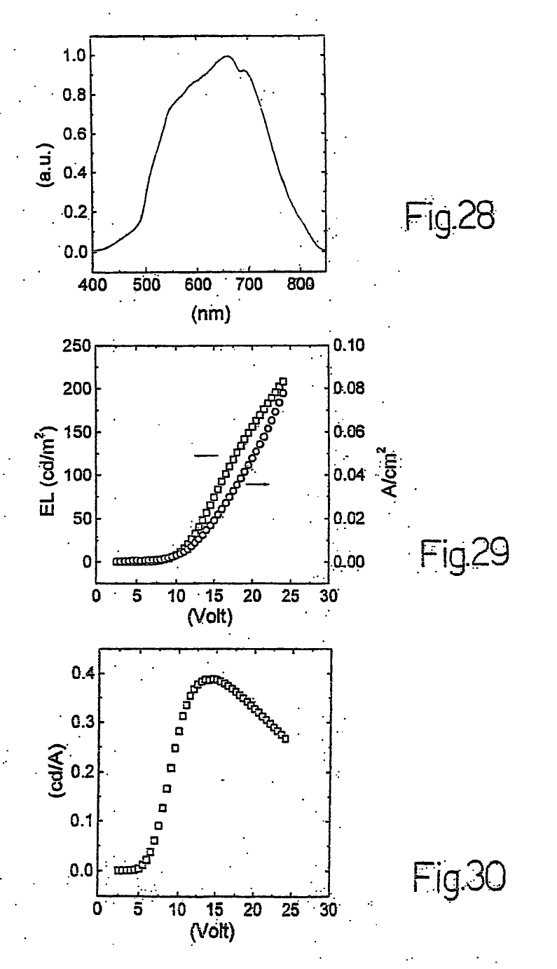

The device thus obtained, which had an active surface of 0.07 cm₂, was tested under laboratory conditions (i.e., with a temperature of between 20° C. and 24° C. and with a humidity of between 55% and 65%) and revealed an electromagnetic emission, illustrated in FIG. 28, in the red, characteristic of the intermolecular aggregate of Pt(ppy)₂. The curves which were obtained experimentally from the use of said device and which represent the intensity of electroluminescence and the current density as a function of the applied voltage are illustrated in FIG. 29. The curve which was obtained experimentally from the use of said device and which represents the efficiency as a function of the applied voltage is illustrated in FIG. 30.

1. An organic electroluminescent device having an anode (2), a cathode (3), and an intermediate element (7), which is set between the anode (2) and the cathode (3) and comprises at least one hole-transporting organic material, and at least one electron-transporting organic material; the electron-transporting organic material and the hole-transporting organic material being designed to form between them exciplexes or electroplexes; the device (1) being characterized in that said intermediate element (7) comprises at least one luminophore material; the luminophore material being designed to emit electromagnetic radiation; the luminophore material being supplied, in use, for transfer of energy from said exciplexes or electroplexes.

2. The device of claim 1, wherein said intermediate element (7) essentially includes a first layer (4), which comprises the hole-transporting organic material and is set in contact with the anode (2), and a second layer (6), which comprises the electron-transporting organic material and is set in contact with said cathode (3) and said first layer (4).

3. The device of claim 2, wherein said first layer (4) comprises the luminophore material.

4. The device of claim 1, wherein said anode (2) is substantially transparent.

5. The device of claim 2, wherein said first layer (4) comprises polycarbonate (PC).

6. The device of claim 1, wherein said electron-transporting organic material has a first ionization potential and said hole-transporting organic material has a second ionization potential; the first ionization potential being higher by at least 0.7 eV than the second ionization potential.

7. The device of claim 1, wherein said electron-transporting organic material has a first electronic affinity and said hole-transporting organic material has a second electronic affinity; the first electronic affinity being higher by at least 0.4 eV than the second electronic affinity.

8. The device of claim 1, wherein said luminophore material comprises at least one metallocyclic compound, which satisfies the structural formula M L L′ L″, in which M represents a transition metal, L, L′ and L″ represent, each independently of the others, a chelating ligand, which satisfies the structural formula: 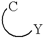
in which Y represents an electron-donor heteroatom.

9. The device of claim 8, wherein M represents iridium (Ir).

10. The device of claim 8, wherein M is positively formally charged.

11. The device of claim 1, wherein said luminophore material comprises at least one metallocyclic compound, which satisfies the structural formula M′ L L′, in which M′ represents a transition metal, L and L′ represent, each independently of the other, a chelating ligand, which satisfies the structural formula: 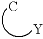
in which Y represents an electron-donor heteroatom; M′ representing a transition metal chosen in the group consisting of:
platinum (Pt); and
palladium (Pd).

12. The device of claim 11, wherein M′ is positively formally charged.

13. The device of claim 8, wherein the chelating ligands L, L′ and L″ satisfy, each independently of the others, a structural formula chosen in the group consisting of: 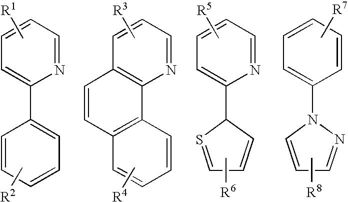
in which R¹, R², R³, R⁴, R⁵, R⁶, R⁷, and R⁸ represent, each independently of the others, one chosen from among:
an alkyl group,
an aryl group,
a condensate ring, or
a hydrogen atom;
L, L′ and L″ being negatively formally charged.

14. The device of claim 8, wherein said metallocyclic compound is iridium tris (2-phenylpyridine) (Ir(ppy)₃).

15. The device of claim 11, wherein said metallocyclic compound is chosen in the group consisting of:
platinum bis (2-thienylpyridine); and
platinum bis (2-phenylpyridine).

16. The device of claim 1, wherein said luminophore material comprises at least one organometallic complex which satisfies the structural formula:
M″ Qₙ A₃₋ₙ,
in which n is comprised between 1 and 3, each Q is, independently of the other Qs, a quinoline derivative, and each A is, independently of the other As, a phenol derivative, and in which M″ is a metal, having a positive formal charge, chosen in the group consisting of:
aluminium (Al), and
gallium (Ga).

17. The device of claim 16, wherein the organometallic complex is alumino bis (phenol)(8-hydroxyquinaldine) (Alqfen₂).

18. The device of claim 1, wherein said luminophore material comprises at least one organometallic complex, which satisfies the structural formula:
M′″ Qₘ A₂₋ₘ,
in which m is 1 or 2, each Q is, independently of the other Qs, a quinoline derivative, and each A is, independently of the other As, a phenol derivative, and in which M′″ is a metal, having a positive formal charge, chosen in the group consisting of:
zinc (Zn), and
beryllium (Be).

19. The device of claim 16, wherein each Q represents, independently of the other Qs, a quinoline derivative, which satisfies a structural formula chosen in the group consisting of: 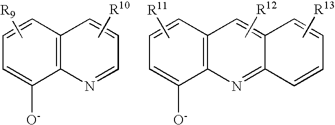
in which R⁹, R¹⁰, R¹¹, R¹² and R¹³ represent, each independently of the others, one chosen from among:
an alkyl group,
a hydrogen atom, or
an aryl group.

20. The device of claim 16, wherein each A is a phenol derivative, which satisfies, independently of the other As, a structural formula chosen in the group consisting of: 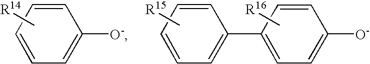
in which R¹⁴, R¹⁵ and R¹⁶ represent, each independently of the others, one chosen from among:
an alkyl group,
a hydrogen atom, or
an aryl group.

21. The device of claim 1, wherein said luminophore material comprises at least one aromatic hydrocarbon with condensate rings, which satisfies a structural formula chosen in the group consisting of: 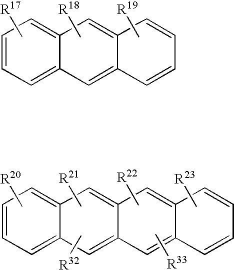
in which R¹⁷, R¹⁸, R¹⁹, R²⁰, R²¹, R²², R²³, R³² and R³³ represent, each independently of the others, one chosen from among:
an alkyl group,
a hydrogen atom, or
an aryl group.

22. The device of claim 21, wherein said aromatic hydrocarbon with condensate rings is rubrene.

23. The device of claim 1, wherein said luminophore material comprises at least one thiophene derivative which satisfies a structural formula chosen in the group consisting of: 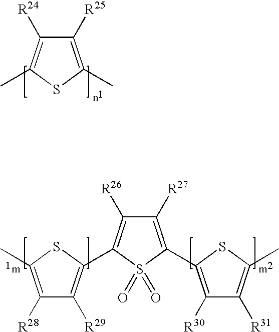
in which n¹ is an integer comprised between 3 and 7, m¹ and m² are, each independently of the other, integers comprised between 1 and 3, in which R²⁴, R²⁵, R²⁶, R²⁷, R²⁸, R²⁹, R³⁰ and R³¹ represent, each independently of the others, one chosen from among:
an alkyl group,
a hydrogen atom, or
an aryl group.

24. The device of claim 1, wherein said hole-transporting organic material is substantially represented by a tertiary aromatic amine; the tertiary aromatic amine satisfying the structural formula: 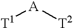
in which T¹ and T² represent, each independently of the other, a tertiary amine; and in which A represents an aryl group.

25. The device of claim 24, wherein T¹ and T² represent, each independently of the other, a tertiary amine which satisfies a structural formula chosen in the group consisting of: 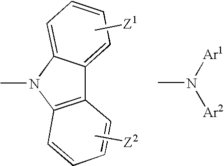
in which Z¹ and Z², represent, each independently of the other, one chosen from among:
an alkyl group,
an alcohol group, or
a hydrogen atom;
in which Ar¹ and Ar² represent, each independently of the other, an aryl group.

26. The device of claim 24, wherein said hole-transporting organic material comprises 4,4′,4″-tris (N-3-methylphenyl-N-phenylamino)-triphenylamine (m-MTDATA).

27. The device of claim 1, wherein said electron-transporting organic material is substantially constituted by a heterocyclic compound which satisfies a structural formula chosen in the group consisting of: 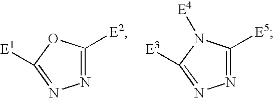
in which E¹, E², E³, E⁴ and E⁵ represent, each independently of the others, an aryl group.

28. The device of claim 1, wherein said electron-transporting organic material comprises 2-(4-biphenyl)-5-phenyl-1,3,4-oxadiazole (PBD).

29. A method for producing an organic electroluminescent device; the method comprising a depositing step for depositing an intermediate element (7) on an anode (2); and an apposition step for positioning a cathode (3) on said intermediate element (7); the intermediate element (7) comprising at least one luminophore material; the luminophore material being designed to emit electromagnetic radiation; the method being characterized in that said intermediate element (7) comprises at least one hole-transporting organic material and at least one electron-transporting organic material; the electron-transporting organic material and the hole-transporting organic material being designed to form between them exciplexes or electroplexes; the luminophore material being supplied, in use, for transfer of energy from said exciplexes or electroplexes.

30. The method of claim 29, wherein said luminophore material is chosen so that said electromagnetic radiation is of a given wavelength.

31. The method of claim 29, wherein said depositing step comprises a first depositing substep for depositing said first layer (4) on an anode (2); and a second depositing substep for depositing the second layer (6) on the first layer (4); of positioning a cathode (3) on said second layer (6).

32. The method of claim 31, wherein, during said first depositing substep, said luminophore material is deposited.

33. The method of claim 31, wherein, during said first depositing substep polycarbonate, is deposited.

34. The device of claim 11, wherein the chelating ligands L, L′ and L″ satisfy, each independently of the others, a structural formula chosen in the group consisting of: 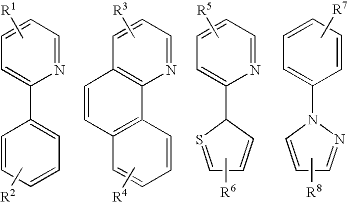
in which R¹, R², R³, R⁴, R⁵, R⁶, R⁷, and R⁸ represent, each independently of the others, one chosen from among:
an alkyl group,
an aryl group,
a condensate ring, or
a hydrogen atom;
L, L′ and L″ being negatively formally charged.

35. The device of claim 18, wherein each Q represents, independently of the other Qs, a quinoline derivative, which satisfies a structural formula chosen in the group consisting of: 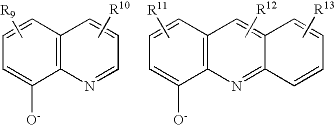
in which R⁹, R¹⁰, R¹¹, R¹² and R¹³ represent, each independently of the others, one chosen from among:
an alkyl group,
a hydrogen atom, or
an aryl group.

36. The device of claim 18, wherein each A is a phenol derivative, which satisfies, independently of the other As, a structural formula chosen in the group consisting of: 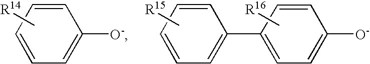
in which R¹⁴, R¹⁵ and R¹⁶ represent, each independently of the others, one chosen from among:
an alkyl group,
a hydrogen atom, or
an aryl group.
